(19) United States
(12) Patent Application Publication
(10) Pub. No.: US 2019/0388294 A1
(43) Pub. Date: Dec. 26, 2019

(54) SURFACE MOUNTABLE MASSAGING APPARATUS

(71) Applicant: Thomas John Chinonis, Royal Oak, MI (US)

(72) Inventor: Thomas John Chinonis, Royal Oak, MI (US)

(21) Appl. No.: 16/432,809

(22) Filed: Jun. 5, 2019

Related U.S. Application Data
(60) Provisional application No. 62/681,053, filed on Jun. 5, 2018.

(51) Int. Cl. A61H 15/00

(52) U.S. Cl. CPC A61H 15/00; A61H 2201/0123; A61H 2201/013; A61H 2015/0014; A61H 2015/0042

(57) ABSTRACT

A massage apparatus that is capable of being releasably attached to upright and other surfaces allowing a user to engage hard to reach spots, such as the back for performing self-application massage therapy. The massage apparatus may include a base having a suction cup and multiple variations of massage attachments that may be interchangeably or permanently affixed to the base.

### CROSS-REFERENCE TO RELATED APPLICATION

This application claims the benefit of U.S. Provisional Application Ser. No. 62/681,053, filed Jun. 5, 2018, which is incorporated herein by reference in its entirety.

### TECHNICAL FIELD

A device and method for conducting self-application massage therapy. The device has a combination of a uniquely designed suction cup combined with a massage attachment for conducting self-application myofascial massage therapy.

### BACKGROUND OF THE INVENTION

Massage Therapy, Generally: Myofascial release is a therapy technique often used in massage. The technique focuses on pain arising from myofascial tissues, which are the connective tissue in the body that wrap and support muscles. Trainers, doctors, chiropractors, massage therapists and physical therapists continue to encourage the use of myofascial release therapy to combat the effects of tight or restricted muscles, and it is fast gaining recognition as the missing link in traditional healthcare for soft tissue and fascial tension conditions. Trauma, inflammatory responses and/or surgical procedures create myofascial restrictions requiring release, whether caused by injury, exercise or other factors. The goal of myofascial therapy is to stretch and loosen the fascia so that it and other connected body parts can move more freely, and motion is restored. For this reason, myofascial therapy is sometimes referred to as “myofascial trigger point therapy.”

There are many methods of myofascial release therapy. While many therapists, doctors or others can apply the therapy to the affected person, there is an increasing market for tools and techniques that are utilized by the affected person individually. These “self-application” tools currently include foam rollers, hand-held massage tools, and self-stretching exercises. While users of self-application therapy gain the benefit of not paying for therapy services, or relying on friends, family or others to administer the therapy, there is an inherent problem with self-application: leverage and access. The present invention solves these problems in the self-application therapy space by creating an entirely new method of self-application: handheld massage units that are temporarily attached to a wall or other surface allowing users to conduct therapy sessions anywhere and at any time.

Self-Application Massage Therapy Issue to be Resolved: To understand the problem of “leverage” in the self-application space, one must look at the most popular devices purchased by consumers and how those devices are utilized. Across the board, users can only gain the force and pressure necessary to target the affected trigger points by either straining to reach difficult-to-reach areas like the upper and lower back and neck, straining other muscles to exert the force necessary to reach trigger points, or getting on a floor and allowing gravity to assist.

For almost every device targeted at reaching the back/spine—which is one of the most targeted areas of myofascial therapy—it is very difficult to bend your arms backwards and then pull or push in a way that allows the tool to dig deep into your muscles. While difficult for any active individual, it is especially challenging for elderly persons, disabled persons or persons with restriction issues who do not have the flexibility necessary to address these trouble areas. While certain devices do exist that bend and loop around from the front of one's body to reach the back area, they are typically large, cumbersome and not something one would typically want a others to see being done in a public realm.

To overcome some of these issues, foam rollers have become increasingly popular self-application devices as they allow users to use gravity to gain leverage. Individuals place a tube-like roller on the floor and roll their body over the targeted areas. Inherently, this requires users to only do the exercise while wearing gym clothes or other clothes that can get dirty, and/or also requires users to find enough space to lay across a floor making it difficult in offices or other public areas. In addition for certain persons who are disabled, elderly or even not at peak fitness, it may be difficult to roll across a floor targeting a specific area.

Another popular method of self-application in hard-to-reach areas is the use of a tennis ball or lacrosse ball placed on a wall, and then leaning against the ball and moving around the ball to relieve the affected area on the back or arms. While this alleviates the problem of contorting awkwardly to reach the back area, as well as prevents one from lying on a floor, it faces another issue: gravity. Quite simply, the ball falls off the wall if any gap exists between it and the person, making a long, uninterrupted therapy session challenging, and very difficult to move or alternate from one target area to another.

### SUMMARY OF THE INVENTION

The present invention solves the leverage and access problems by being the first device that combines a unique attachment system to various massage attachments that temporarily adhere to surfaces such as walls, doors and glass. This allows users to lean into any of the various devices without straining, without contorting in weird directions, without getting dirty on the floor, and without having the device fall to the ground after a few minutes of use, while at the same time allowing users to effectively target hard-to-reach areas such as the upper and lower back, neck, arms and legs. When users complete their self-application massage therapy, they can remove the device from the surface. The temporary element of this solution allows individuals to gain the important leverage necessary for the trigger point massage in any home, office, or other space, while not requiring users to permanently mount tools to home or office walls and/or doors. A defining feature of the device, however, is that it is being designed with a substantial sticking device, e.g., a suction cup base so that users can freely engage the device with force to generate deep trigger point massage relief and not have it disengage unintentionally from the vertical surface to which it is attached, before easily removing it from the surface when the therapy is finished.

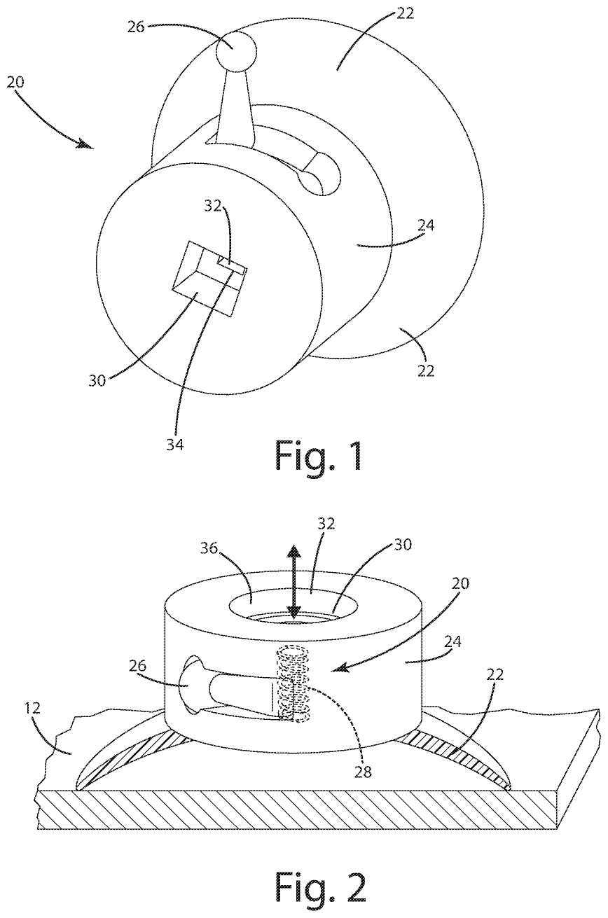

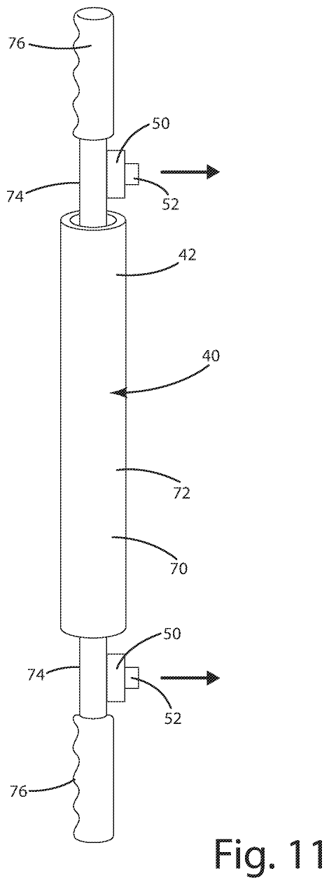

Each device has a different massage “head” or shape on one end that is aimed at applying a different method of myofascial therapy, and a simple-yet-strong unique suction cup on the other end that allows adhesion to various flat surfaces. In addition, the device may be configured with multiple suction cups such as the massage rolling stick illustrated in FIG. 11 to be combined with suction cup bases of FIG. 1. More specifically, a roller mounted on a spindle with two suction cup units—one at each end of the stick—that allows users to use it as both a traditional massage rolling stick (held by two hands and used to massage thighs, calves, etc.), as well as affixing to a wall to allow users to lean against and roll their upper and lower back and neck. The massage stick may include a feature of detachable suction cup mounts to allow users the freedom to use the massage stick with or without the suction cups when using on legs or other body parts that do not require the use of a wall in order to gain leverage.

Additional components to the devices are a leverage pedestal for users to stand on while utilizing one of the devices of the present invention, a door mount for the devices to be inserted into for longer periods of use on a door, and a plastic or glass mounting plate that can be permanently or temporarily attached to a wall by fasteners or adhesives so that the devices can be used in spaces that may not have smooth surfaces for the suction cup mounts. Furthermore, the mounting plate could even include a saddle feature for placing and attachment point for the devices over a door or the back of a chair without requiring fasteners or adhesives. As mentioned above, a defining feature of the present invention is, the unique combination of strong adhesion of the devices to vertical surfaces to enable deep trigger point therapy, while also allowing the flexibility to remove and utilize in multiple places.

The various massaging attachments for the devices are selectively attachable to the suction cup base via a connection. The connection could be any type of connection known in the art to keep the massaging attachment attached to the suction cup base during moments of high torqueing force. It should also be appreciated that the connection could keep the massaging attachment static, or it could include a ball joint or the like for allowing rotational movement of the massaging attachment. It should also be appreciated that the connection could include tabs providing a snap fit. The massaging attachments can be hard or elastic and could include any number or shape of prongs and contact points. The massaging attachments could also be configured to provide electronic or motorized movement or vibration. The contact points, i.e., where the massage attachment comes into contact with the user, could have any number of surface characteristics including but not limited to smooth, splined, ribbed, or defining a plurality of projections extending therefrom.

While there are multiple proposed embodiments of the suction cup base for the device, the invention is not limited to the embodiments described herein. It should be appreciated that the suction cup could be any form of suction cup known in the art so long as it is capable of creating a suction force great enough to retain the connection between the device and the surface on which it is mounted during massaging action. Furthermore, the description has emphasized the placement of the device on a smooth vertical surface, it should also be appreciated that the device could be attached to the floor or any other surface such as a table top, bar, or other surface. As a non-limiting example, the device could be placed on a tile floor and the user could massage their legs or feet therewith. It should also be appreciated that the suction cup is designed to hold the device in areas with a lot of moisture, such as a shower. The suction action can be biased via an internal spring, a piston, or the like. In one embodiment, the suction cup base could include more than one suction cup.

The roller stick or massager includes a shaft extending between two handles, a connection adjacent to each handle, and a medially located roller extending about the bar. It should be appreciated that such a design could also include a singular connection. In one example of the singular connection roller massager, the shaft is folded into the general shape of a cloths hanger, wherein the widest portion includes a roller and the narrowed portion that generally includes a hook for hanging includes the connection. As with the various massage attachments, the roller can have any number of surface characteristics including but not limited to hard, soft, splined, ribbed, or defining a plurality of projections extending therefrom.

The door mount and the mounting plate could also be combined such that the mounting plate is located on the height adjustable mounting section of the frame of the door mount. The leverage pedestal could have any pitch and surface characteristics suitable for providing leverage to a user.

In yet another embodiment, the suction cup base could be configured to spin and/or move the massaging attachments to provide electronic or motorized movement against the user without the user having to move.

### DETAILED DESCRIPTION OF THE DRAWINGS

FIG. 1 is a top perspective view of a base including a suction cup to which a massage portion is attached to form the massage apparatus.

FIG. 2 is a side perspective view of base in FIG. 1 with the suction cup in cross section and mounted to a surface.

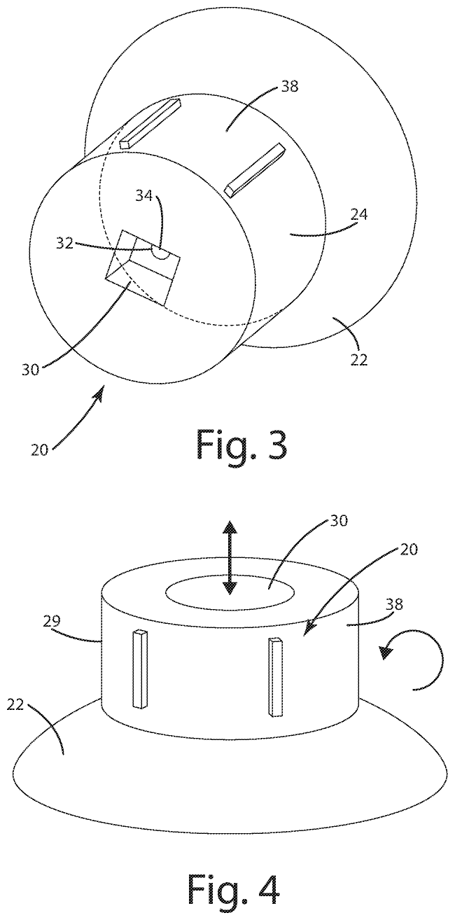

FIG. 3 is a perspective view of an alternative base.

FIG. 4 is a side view of the base in FIG. 3.

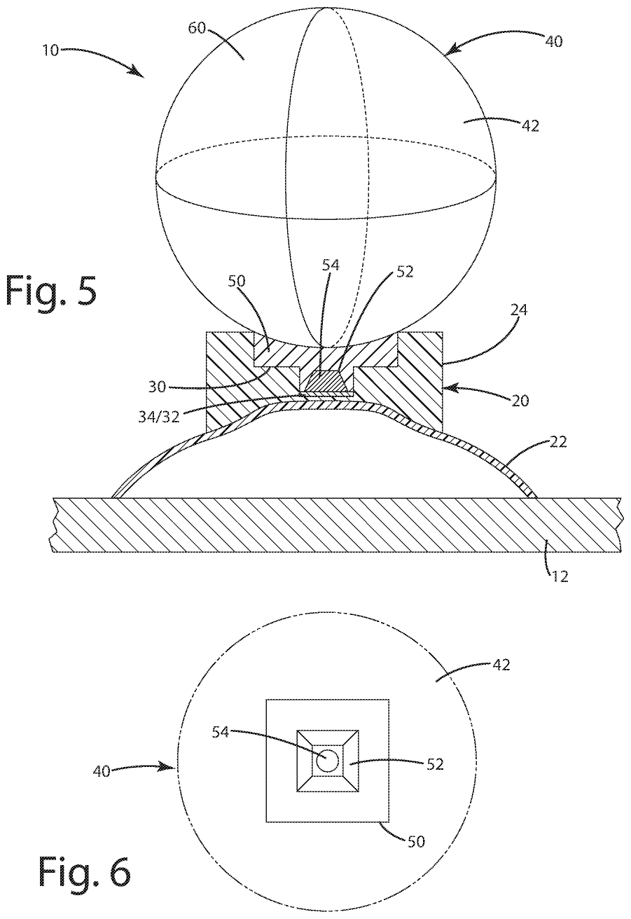

FIG. 5 is a side view of a first massage attachment having a hard ball.

FIG. 6 is a bottom view of the first massage attachment from FIG. 5.

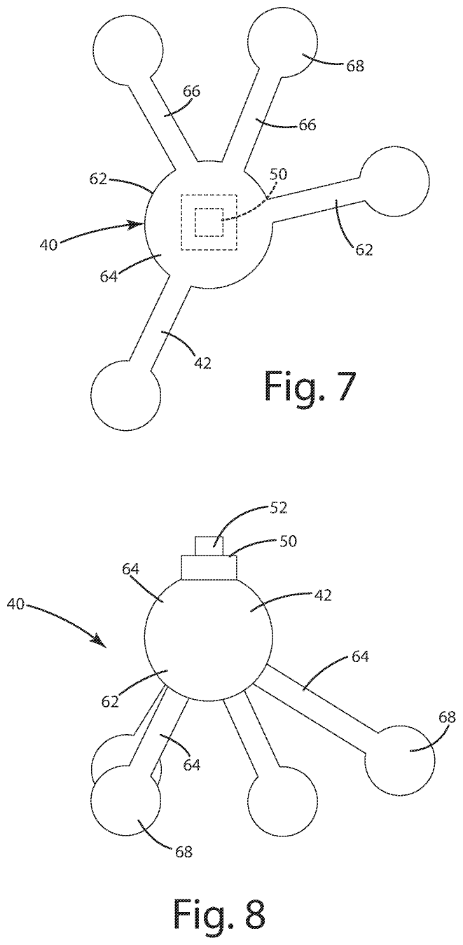

FIG. 7 is a top view of a second massage attachment having an exemplary number of prongs.

FIG. 8 is a side view of the second massage attachment in FIG. 7.

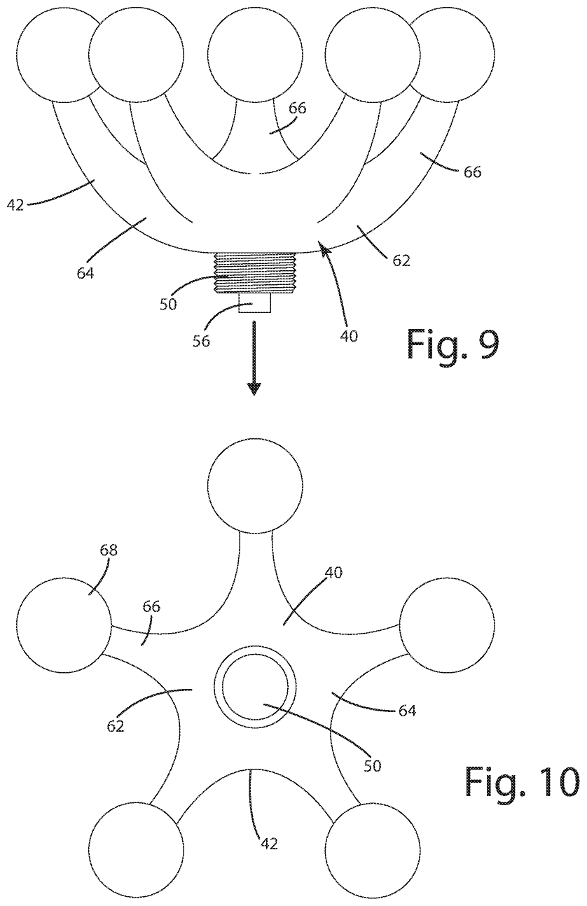

FIG. 9 is a side view of a third massage attachment having an exemplary number of prongs.

FIG. 10 is a side view of the third massage attachment in FIG. 10.

FIG. 11 is a side view of a fourth massage attachment.

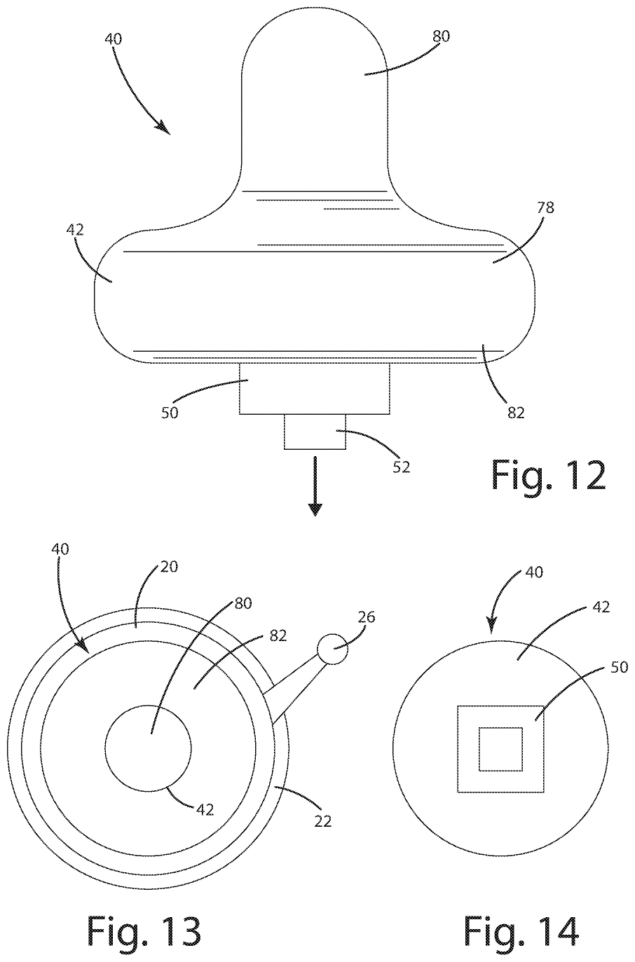

FIG. 12 is a side view of a fifth massage attachment.

FIG. 13 is a top view of the massage attachment in FIG. 12.

FIG. 14 is a bottom view of the massage attachment in FIG. 12.

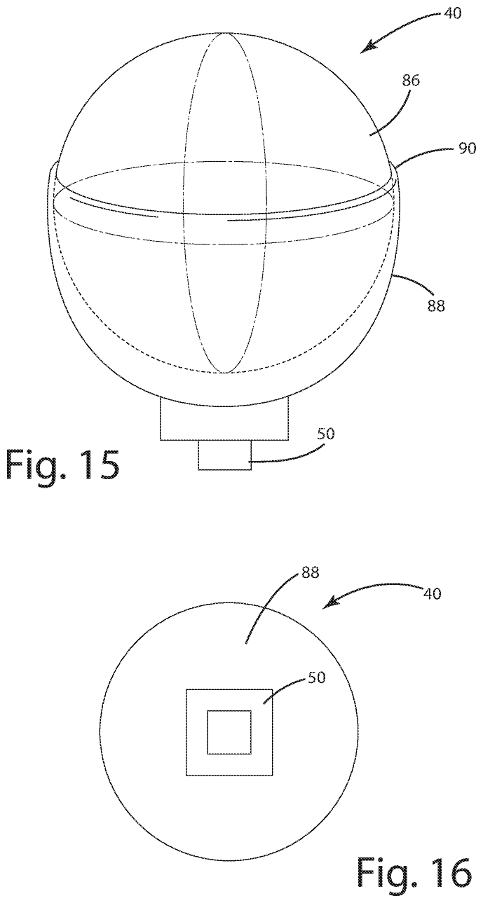

FIG. 15 is a side view of a sixth massage attachment having a moveable portion.

FIG. 16 is a bottom view of the sixth massage attachment in FIG. 15.

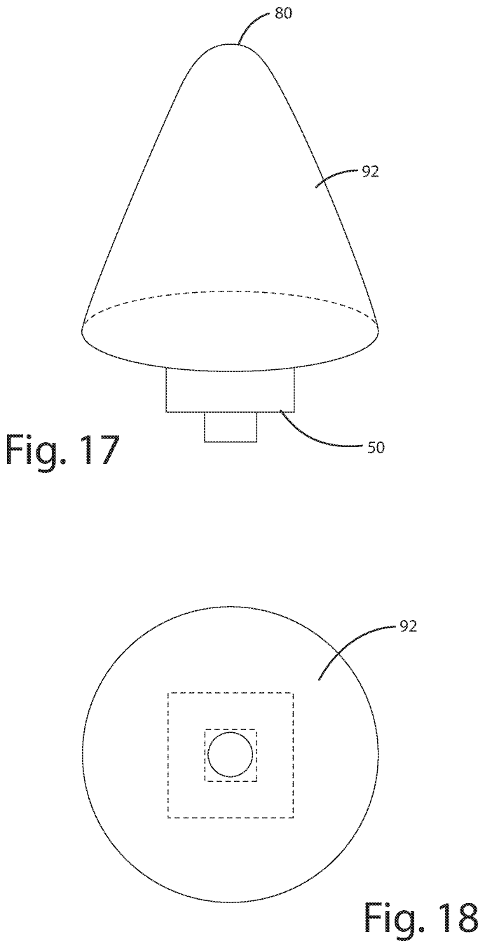

FIG. 17 is a side view of a seventh massage attachment.

FIG. 18 is a top view of the massage attachment in FIG. 17.

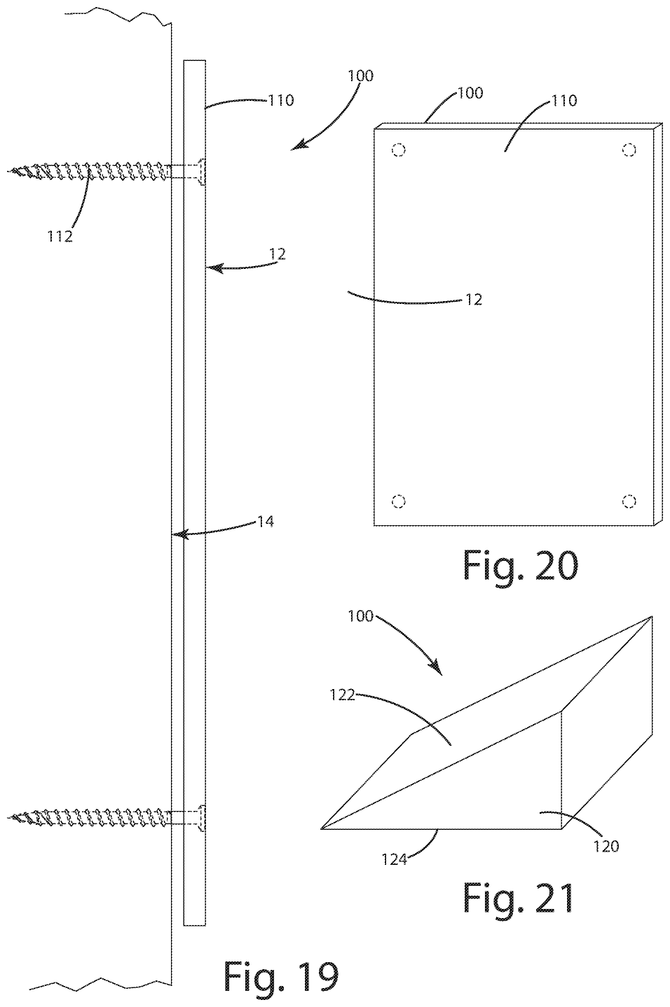

FIG. 19 is a side view of an exemplary mounting plate being mounted to a surface.

FIG. 20 is a top view of the mounting plate in FIG. 19.

FIG. 21 is a perspective view of a leverage pedestal.

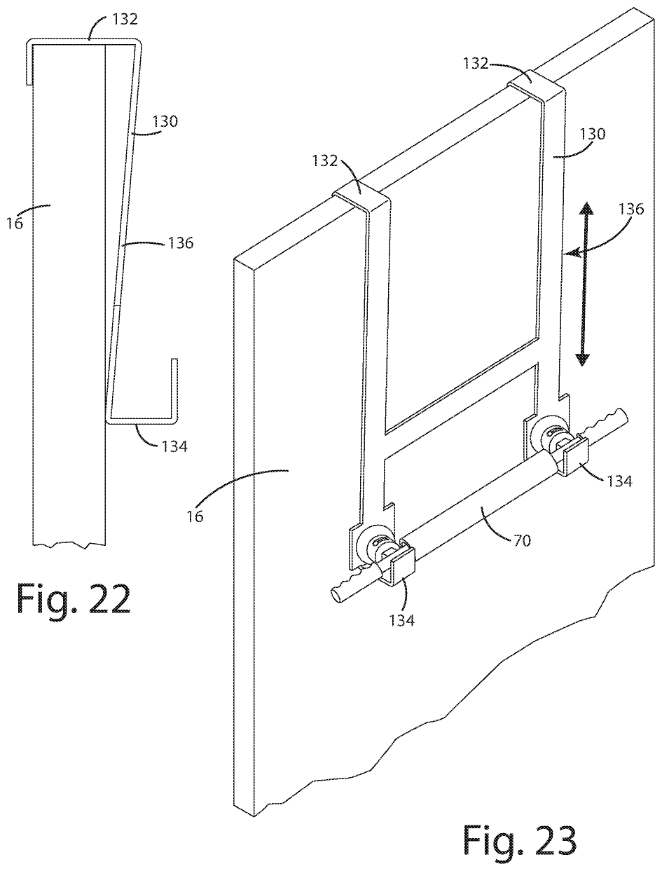

FIG. 22 is a side view of a door mount coupled to a door.

FIG. 23 is a front view of a double door mount coupled to a door.

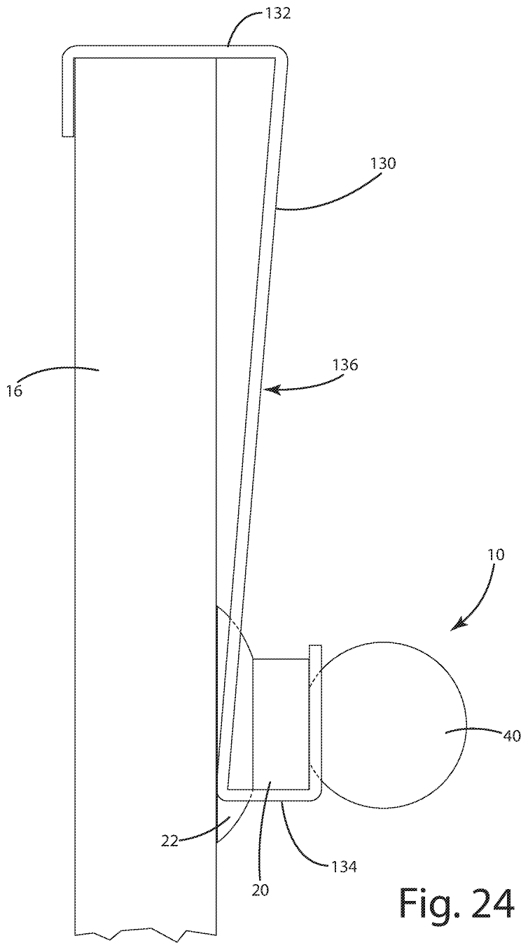

FIG. 24 is a side perspective view of a door mount holding a device in place.

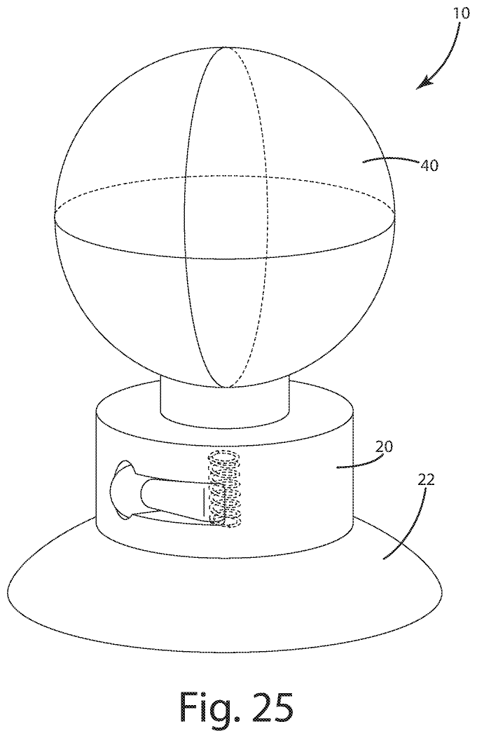

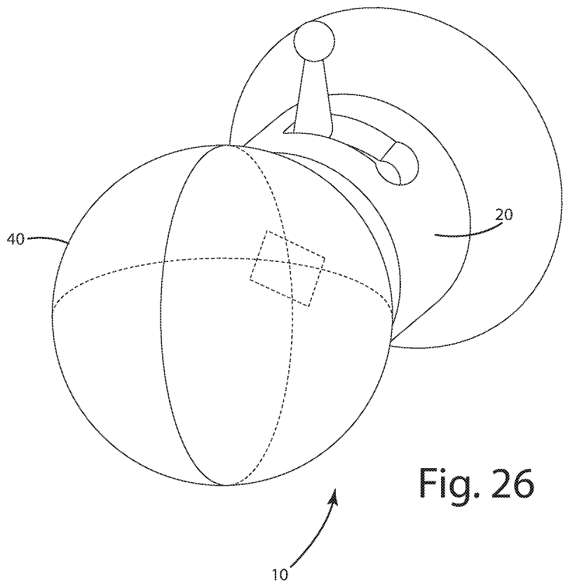

FIG. 25 is a front view of a sphere massager with a permanently affixed base.

FIG. 26 is a top view of the sphere massager in FIG. 25.

FIG. 27. Is a front view of a finger massager with a permanently affixed base.

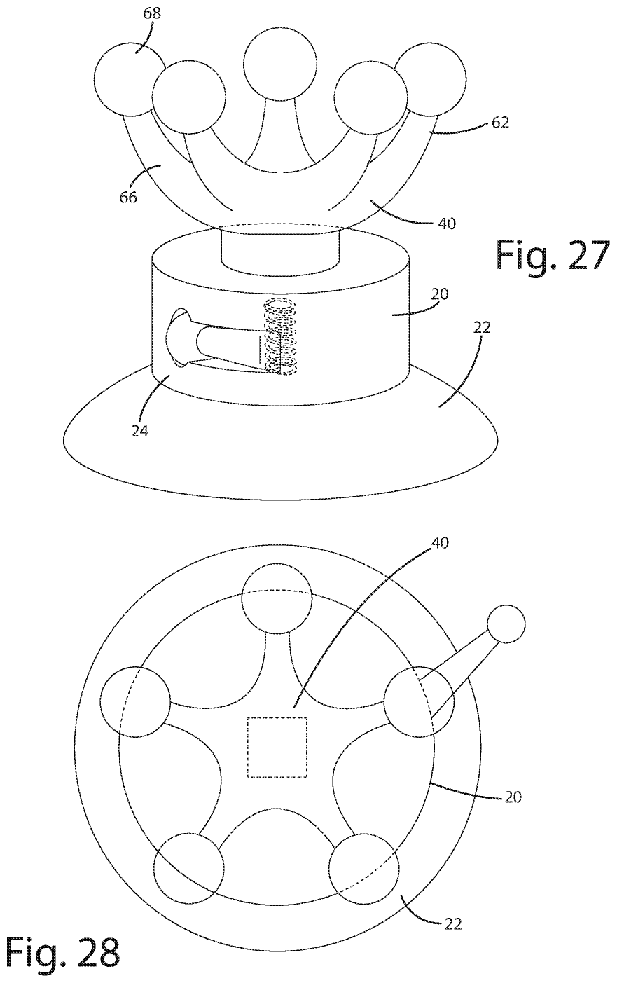

FIG. 28 is a top view of the finger massager in FIG. 27.

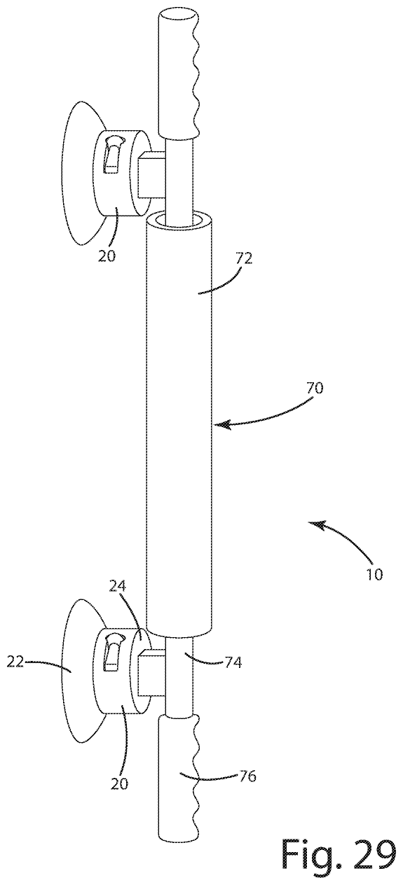

FIG. 29 is a font perspective view of a roller massager with two permanently affixed bases.

### DETAILED DESCRIPTION

A massage apparatus 10 is configured to be mounted to a mounting surface 12 such as a door, building wall or other vertical structure, or any other desired surface including the ground or an inclined plane. If mounted to a door 16, as described below, a door mounting device 130 may be used to help secure it in place. The massage apparatus 10 generally includes a base 20, which attaches to the mounting surface 12 and a massage attachment 40, which is what is used to engage a person and provide the desired benefits as described above. The base 20 generally includes a suction cup 22 attached to a body 24 that includes a receiver 30 configured to receive and retain the massage attachment 40. The base 20 may be securely affixed to the massage attachment 40 and not generally releasable for any of the illustrated massage attachments 40.

The base 20 may use a variety of methods to engage or disengage the suction cup 22 such as the illustrated lever 26 or a twist mechanism 38. The lever 26 may include a spring 28 and a cam (not illustrated) to maintain it between the engaged and disengaged positions as illustrated in FIGS. 1 and 2. The receiver 30 may further include an attachment mechanism such as the illustrated magnet 34 in FIG. 1 or a threaded attachment mechanism 36 as illustrated in FIG. 2. Instead of a lever 26 the base 20 may use the twist mechanism 38 as illustrated in FIGS. 3 and 4.

The massage attachment 40 generally is formed having a massage portion 42 configured to engage the individual and the attachment portion 50 configured to attach the massage portion to the base 20. The attachment portion 50 generally includes a protrusion 52 configured to fit within the receiver 30. Although the receiver 30 and protrusion 52 are illustrated as either a square or circle other types of shapes and configurations such as triangles and octagons may of course be used. The protrusion 52 may be permanently affixed to the receiver 30 or releasably affixed such as by a magnet 54 as illustrated in FIG. 6 which secures it to the magnet 34 in the base 20. A rare earth magnet may be used to secure these together with enough force to prevent accidental dislodgment of the massage attachment 40 for the base 20 while in use. Of course in most instances the user will be pressing the massage attachment 40 toward the base 20 so the magnets 34 and 54 work well at releasably securing the massage attachment 40 toward the base 20. Of course, as illustrated in FIG. 9, a threaded fastener 56 may be on the protrusion 52 to engage a threaded attachment 36 within the receiver 30.

The massage apparatus 10 may be configured to have interchangeable massage attachments 40 to allow different pressure points or types of massages to be performed using a single base 20. For example, as illustrated in FIGS. 5 and 6 the massage attachment portion 40 may be sphere massager 60. As illustrated in FIGS. 7 and 8 as well as FIGS. 9 and 10 the massage attachment 40 may have a massage portion 42 which is a finger massager 62. The finger massager 62 may include the base 64 with fingers 66 extending therefrom into engagement knobs 68 which may have a variety of sizes and shapes to provide the desired engagement with the individual. In addition, the number of fingers 66 are only exemplary and may vary depending upon the desired engagement. The positioning and length of the fingers 66 may vary as well as relative to one another to provide desired engagement with an individual.

As illustrated in FIG. 11 the massage attachment 40 may be the roller massager 70 having a shaft 74 on which a cylindrical cover 72, which may be formed of a hard material, a foam material, or other desired materials, may extend around. The cylindrical cover 72 may be configured to rotate about the shaft 74 or be stationary to it. The shaft 74 on each side of the cylindrical cover 72 may include attachment portions 50 allowing it to be inserted into two bases 20, or fixably secured to two bases which allow a roller massager 70 for the first time to be releasably attached to a wall surface using the unique base 20. The roller massager 70 has a massage attachment 40 may be removed from the bases 20 and by the individual grasping the handles 76 on each end of the shaft 74 may be used to get to areas that are hard to reach when it is mounted to a surface 12.

As illustrated in FIGS. 12 through 14, a lobe or tip massager 78 may be used to have an engagement protrusion or tip such as a single finger 80 extending outwardly from a lower outer protrusion 82. The lower outer protrusion 82 may extend cylindrically around the attachment portion 50. As illustrated in FIGS. 15 and 16 a rotating ball massager 84 may be used having a ball 86 retained within a retention base 88. The retention base 88 extends slightly beyond the curve of the half way point of the sphere or ball 86 to create a retaining lip 90 that holds the ball 86 in place while allowing it to rotate freely in any direction. As illustrated in FIGS. 17 and 18, a cone massager 92 may also be used which allows different engagement with the individual than the illustrated lobed massager 78.

As all surfaces may not be configured to easily attach a suction cup device or may not be desirable to adhesively or double sided tape attach the suction cup to a surface, the present invention of the massage apparatus may include an attachment device 100. For example, if the structure surface 14 such as a wall or door is not conducive to a suction cup attachment and it is not desirable to adhesively attach or double sided tape attach the base 20 to the surface 14, a mounting or attachment device 100 such as an illustrated mounting plate 110 may be used. For example, wallpaper may not provide a good surface to which to adhere the suction cup 22. As such, an attachment such as illustrated mounting plate 110, which is fastened to the wall or structure surface 14 with fasteners 112 may provide a smooth surface to which a suction cup may adhere. For example, the attachment device 100 may be formed out of a glass and highly stylized surface that looks like a piece of art work on the wall but it disguises that a mounting surface 12 is being provided to easily attach the base 20 of the massage apparatus 10 thereto. The mounting plate 110 is illustrated in FIGS. 19 and 20. In some instances, it may be desired to have a mounting plate 110 that is leverage pedestal 120 that may be attached to the wall, laid on the ground, or laid on some other surface to provide a different angle of engagement of the massage attachments to the individual during use. Leverage pedestal 120 as illustrated in FIG. 21 generally includes an inclined plane surface 122 having the mounting surface 12 thereon and a pedestal base 124 resting on the structure surface 14.

In addition, a door mounting device 130 may be used. The door mounting device 130 generally includes hooks 132 that hook over the top edge of the door 16 and extend downward to a massage device retainer 134. The legs 136 that extend between the upper hook 132 and the massage device retainer 134 may be height adjustable to allow for different users to hit the desired points of engagement on their body. The upper hooks 132 may also be adjustable in width to accommodate different size doors as well as the massage device retainer 134 may have different size, shapes and configurations depending on the types of bases 20 and massage attachments 40 used. In some instances, the door mounting device 130 is just an additional security to ensure that the suction cups 22 stay attached to the door 16. As illustrated in FIG. 23, the door mounting device includes two legs extending down to two massage device retainers 134 to accommodate a device such as the illustrated roller massage 70.

As described above, there are multiple different heads or massage attachments 40 that will couple to the base 20, either fixably or releasably. Please note that the massage attachments have been shown separate from the bases 20 in most figures for ease of illustration, most massage attachments 40 may be fixed to the bases 20, including permanently. The base 20, together with each massage attachment 40 each referred to as a “Massage Apparatus 10.” The descriptions below regarding the apparatus in the figures provide several non-limiting examples thereof. In addition, the leverage pedestal 120, door mount device 130 and mounting plate 110 may form part of the apparatus 10. For ease of illustrations, the base 20 was illustrated separately, but the same base 20 may be utilized for each of the attachments 40, including multiple bases 20 for the roller massager 70, including being permanent affixed.

As illustrated in FIG. 1, a first base 20 includes a suction cup 22 that is engaged or disengaged by a lever system having a lever 26, and in some instances a spring 28. To engage the rubber suction cup 22, users place the suction cup 22 against a flat surface 14 and close the lever down into the recessed sidewall of the body 24 of the base 20. A spring 28 and cam inside the base 20 are engaged with this closing movement, thereby lifting the center of the suction cup 22, as illustrated in FIG. 5, which creates a vacuum and allows the suction cup 22 to adhere to the surface 14. To release, users pull the lever 26 up, which will release the center of the suction cup back to a down or neutral position, eliminating the vacuum and releasing the adhesion of the suction cup 22 to the surface 16 or 12.

A variation of the base 20 is illustrated in FIGS. 3 and 4 where the suction cup 22 is engaged and disengaged by a twisting motion of the body 24. More specifically, to engage the rubber suction cup 22, users place it against a smooth surface 12 or 16 and twist the rotating sidewall of the body 24, which will engage a spring and cam or an inclined plane, or a helical device inside the middle of the base 20 thereby lifting the center of the suction cup 22 to create a vacuum and allowing the suction cup 22 to adhere to the surface 12. To release, users twist the sidewall in opposite direction, which will release the center of the suction cup 22 back to a “down” or neutral position, pushing air back out and releasing the adhesion.

Both of the proposed bases 20, if a releasable system is used it will have a male or female component, illustrated as a female receiver in the Figures on the top of the base 20, allowing the base to attach to each of the massage attachments 40 directly via the protrusion 52 of the attachment portion 50. The attachment of the massage attachments 40 to the base 20 component may be permanent as a final step in production process, or may have the functionality of allowing users to remove/attach the massage attachment with each use, as described above.

A hard ball or sphere massager 80 is illustrated in FIGS. 5 and 6. A solid or hard plastic glass, rubber or other sphere 86 will be affixed to the base 20. The sphere massager 80 simulates the approximate size of a standard lacrosse or tennis ball, but will not roll and may have a smooth surface allowing users to slide across the body and engage deep tissue, or a texture surface, such as dimples or small protrusions.

A multi-prong massager 62 is illustrated in FIGS. 7 through 10. Four solid or hard plastic or other material arms or fingers 66 will be affixed to a base 64 which is in turn fixed to the base 20. Each finger 66 will have a spherical bulb or engagement knob 68 at the end with smooth or textured surface allowing users to slide across the body and engage deep tissue but with a smaller surface engagement head than the sphere massager 60.

A second finger massager 62 is illustrated in FIGS. 9 and 10 with five fingers 66. In some embodiments the fingers 66 may be formed with some flexibility to allow at least one finger to flex to allow engagement by the other fingers 66. Any number of fingers may be used.

A roller massager 70 is illustrated in FIG. 11. A foam, rubber or plastic roller or cylindrical cover 72 will articulate or roll around an axle or shaft 74. At the ends of the shaft 74 are handles 76 for users to hold and engage the roller 70 when it is not affixed to a surface. On the inside of each handle 76 will be a male or female attachment portion 50 for attaching to the base 20. The roller massager 70 may be permanently attached to the base 20, or users may be able to attach and detach the base 20. The roller or cylindrical cover 72 will be foam, plastic or other dense material.

A rounded tip massager or lobed massager 78 as illustrated in FIGS. 12 through 14. A rounded hard rubber, plastic tip or engagement protrusion 80 will extend from the base 20, either permanently or releasably attached as illustrated in FIGS. 13 and 12 respectively. The rounded single point of contact of the engagement protrusion or tip 80 will allow a deep penetrating pressure point for targeted trigger point therapy similar to a human finger.

A roller ball massager is illustrated in FIGS. 15 and 16. A hard sphere/ball 86 will articulate inside a plastic/hard shell or retention base 88 that is affixed to the base 20 either releasably or permanently. Users will be able to roll the ball 86 along their back, neck and other parts of the body. For back therapy a vertical mounting surface may be useful but for legs some non-vertical surface may be useful.

A pointed tip massager or cone massager 92 is illustrated in FIGS. 17 and 18. A pointed hard rubber or plastic tip or engagement protrusion 80 will extend from the base 20. The pointed single point of contact will allow a deep penetrating pressure point for targeted trigger point therapy similar to a human finger.

A mounting plate 110 is illustrated in FIGS. 19 and 20. An exemplary plate 110 would be approximately 36″ wide×24″ long smooth surface, plastic, glass or similar, with mounting screws or other attachment mechanisms so that the plate 110 can be permanently attached to a wall or door. The plate 110 is not required in order to use the apparatus, but its purpose is to enable any facility that may not have smooth surfaces or nonporous surfaces to accommodate the apparatus 110.

Another attachment device 100 is the leverage pedestal 120 illustrated in FIG. 21. An exemplary leverage pedestal may be approximately 24″ wide×24″ deep×8″ high, although other sizes may be used. The pedestal 13 may rest on the floor or other surface and may have a non-skid bottom 124. Users place the pedestal 120 a few feet away from the wall or door where the apparatus is mounted, with the low end of the pedestal 120 facing the wall where the apparatus 10 Device is located, they stand on the angled face 22 with their back toward the wall. The purpose of the leverage pedestal 120 is to allow users to position their body in such a way as to generate additional pressure onto the apparatus and thereby creating a deeper trigger point massage. In addition, as described above the leverage pedestal 120 may be used to mount the apparatus 10.

The door mount is illustrated in FIGS. 22 through 24, and in the exemplary embodiment is approximately 36″ high×18″ wide although other sizes may be used and the height is adjustable to accommodate different users. The door mount rests over a standard door with a metal, plastic or other hard material bracket. Plastic or other hard material hangs down from the top of the door bracket approximately 3 feet, which may vary, with a retention device 134 at the bottom that holds up to two of the apparatuses. The purpose of the door mount 130 is to allow the apparatuses to be inserted into the door mount device so that the apparatus 10 can be used and stay on a door beyond the time the suction cup 22 loses engagement.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features are, for clarity, described herein in the context of separate embodiments, may also be provided in combination in a single embodiment. Conversely, various features that are, for brevity, described in the context of a single embodiment, may also be provided separately or in any sub combination. Further, references to values are to be regarded as non-limiting examples.

What is claimed is:

1. A massage apparatus comprising:
a base having a suction cup and a receiver;
a massage attachment including a massage portion and an attachment portion, the attachment portion being configured to be securely yet releasably inserted into and retained within said receiver.

2. The massage apparatus of claim 1 wherein each of said receiver and said attachment portion include an attachment device.

3. The massage apparatus of claim 2 wherein said attachment device is a magnet.

4. The massage apparatus of claim 2 wherein said attachment device is a threaded insert.

5. The massage apparatus of claim 1 wherein said massage portion is a sphere.

6. The massage apparatus of claim 1 wherein said massage portion includes a base portion from which fingers having engagement portions extend.

7. The massage apparatus of claim 1 wherein said massage portion is a roller massager having a shaft covered by a cylindrical cover and said attachment portion on each side of the cylindrical cover and handles on the outer edges of the shaft.

8. The massage apparatus of claim 1 wherein said massage portion is a lobed massager having a central engagement portion extending upward from the base and an outward extending periphery, with a radiused slop there between.

9. The massage apparatus of claim 1 wherein said massage portion is a rotating ball massager having a ball retained within a cup.

10. The massage apparatus of claim 1 wherein said massage portion is a cone massager.

11. A massage apparatus configured to mount on a surface said apparatus comprising:
a base having a mounting device and receiver
a plurality of massage attachments having a massage portion and an attachment portion, wherein said attachment portion includes a protrusion configured to be received and retained within said receiver, and wherein said massage attachments are configured to be interchangeable.

12. The massage apparatus of claim 1 wherein each of said receiver and said attachment portion include an attachment device.

13. The massage apparatus of claim 12 wherein said attachment device is a magnet.

14. The massage apparatus of claim 12 wherein said attachment device is a threaded insert.

15. The massage apparatus of claim 11 wherein said massage portion is a sphere.

16. The massage apparatus of claim 11 wherein said massage portion includes a base portion from which fingers having engagement portions extend.

17. The massage apparatus of claim 11 wherein said massage portion is a roller massager having a shaft covered by a cylindrical cover and said attachment portion on each side of the cylindrical cover and handles on the outer edges of the shaft.

18. The massage apparatus of claim 11 wherein said massage portion is a lobed massager having a central engagement portion extending upward from the base and an outward extending periphery, with a radiused slop there between.

19. The massage apparatus of claim 11 wherein said massage portion is a rotating ball massager having a ball retained within a cup.

20. The massage apparatus of claim 11 further including an attachment device.

21. The massage apparatus of claim 20 wherein said attachment device is a mounting plate configured to be mounted to a surface and having a mounting surface for releasably engaging said base with said suction cup.

22. The massage apparatus of claim 20 wherein said attachment device is an leverage pedestal having an inclined plane to vary the angle of the massage attachment relative to a surface.

23. The massage apparatus of claim 20 wherein said attachment device is a door mounting device including an upper hook for securing said door mounting device to a surface such as a door.

24. The massage apparatus of claim 23 wherein said door mounting device includes an upper hook to be secured to the top of the door a massage device retention mechanism and at least one leg extending there between.

25. The massage apparatus of claim 24 wherein said legs are height adjustable.

26. The massage apparatus of claim 24 wherein said door mounting device includes at least massage device retention mechanisms configured to securely restrain a roller massager on each end.
